(19) United States
(12) Patent Application Publication
(10) Pub. No.: US 2004/0155832 A1
(43) Pub. Date: Aug. 12, 2004

(54) Compact and low-profile antenna device having wide range of resonance frequencies

(75) Inventor: Dou Yuanzhu, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/737,488

(22) Filed: Dec. 15, 2003

(30) Foreign Application Priority Data
Dec. 16, 2002 (JP) 2002-363888

(51) Int. Cl. H01Q 1/36

(52) U.S. Cl. 343/895; 343/702

(57) ABSTRACT

An antenna device includes a meandering radiating conductor plate composed of a metal ribbon having a predetermined width that is folded a plurality of times so as to meander, a capacitive conductor plate disposed substantially parallel to a ground conductor and connected to the top end of the meandering radiating conductor plate, a connection conductor plate for electrically shorting the capacitive conductor plate to the ground conductor, and a straight radiating conductor plate extending upwardly in a vertical direction and being connected to the bottom end of the meandering radiating conductor plate. The antenna device operates as a dual-band antenna where the meandering radiating conductor plate resonates by feeding first high-frequency power and the straight radiating conductor plate resonates by feeding second high-frequency power that has a higher frequency than that of the first high-frequency power.

### BACKGROUND OF THE INVENTION

1. Field of the Invention

The present invention relates to a compact and low-profile antenna device suitable for being incorporated in in-car communication devices.

2. Description of the Related Art

Antenna devices having a meandering radiating conductor formed on the surface of a substrate by patterning, as shown in FIG. 4, have been known as compact and low-profile antennas which can be incorporated in in-car communication devices (refer to, for example, Japanese Unexamined Patent Application Publication No. 2000-349532, in particular, pages 3 to 4 and FIG. 1). In an antenna device 1 shown in FIG. 4, a meandering radiating conductor 3 composed of a copper film is disposed on the surface of a dielectric substrate 2, which is vertically mounted on a ground conductor plate 4. Predetermined high-frequency power is fed to the bottom end of the radiating conductor 3 via a feed line, such as a coaxial cable. The radiating conductor 3 formed in a zigzag meandering shape has a significantly decreased height compared to a radiating conductor formed in a straight shape having the same electrical length, thereby advantageously reducing the profile of the whole body of the antenna.

Also, antenna devices having a radiating conductor composed of two connected meandering lines with different pitches on the surface of a substrate, as shown in FIG. 5, have been known as compact antennas which are capable of transmitting or receiving signal waves in two frequency bands (refer to, for example, Japanese Unexamined Patent Application Publication No. 2001-68918, in particular, pages 3 to 4 and FIG. 1). In a dual-band antenna device 5 shown in FIG. 5, a radiating conductor 8 composed of a copper film is formed, by patterning, on the surface of a dielectric substrate 7 which is vertically mounted on a ground conductor plate 6, and the radiating conductor 8 is formed such that a first radiating conductor portion 8a, which extends from the vicinity of a feed point in a meandering fashion with a relatively wide pitch, is connected to a second radiating conductor portion 8b, which extends from the top of the first radiating conductor portion 8a in a meandering fashion with a relatively narrow pitch. Therefore, when first high-frequency power is fed to the feed point of the radiating conductor 8 via a feed line, such as a coaxial cable, the whole radiating conductor 8 from the first radiating conductor portion 8a to the second radiating conductor portion 8b can be resonated at a first frequency f₁. In addition, when second high-frequency power is fed to the feed point, only the first radiating conductor portion 8a can be resonated at a second frequency f₂ which is higher than the first frequency f₁. That is, since hardly any higher frequency electrical current flows in the meandering line with the narrow pitch (the second radiating conductor portion 8b), only the first radiating conductor portion 8a can be operated as a radiating element for the second frequency f₂.

In the above-described antenna devices 1 and 5, an excessively small meander pitch, namely the zigzag interval, tends to cause high-order modes. To facilitate reduction of the height, the radiating conductors 3 and 8 may be composed of narrower ribbons. However, the narrow radiating conductors 3 and 8 cause a narrow resonance frequency band, making it difficult to reduce the profile of the antenna devices 1 and 5 while ensuring a sufficient frequency bandwidth.

In particular, in the dual-band antenna device 5, the two radiating conductor portions 8a and 8b having different meander pitches are connected in series. Consequently, the length of the radiating conductor 8 becomes long, thus making it difficult to reduce the profile of the whole body of the antenna.

### SUMMARY OF THE INVENTION

Accordingly, it is a first object of the present invention to provide an antenna device having a wide resonance frequency band and allowing for easy reduction of the size and the height. It is a second object of the present invention to provide a dual-band antenna device having a wide resonance frequency band and allowing for easy reduction of the size and the height.

To achieve the first object, an antenna device according to the present invention includes a radiating conductor plate composed of a metal ribbon having a predetermined width that is folded a plurality of times so as to meander and a supporting substrate having a ground conductor thereon, wherein the radiating conductor plate is vertically mounted on the supporting substrate and high-frequency power is fed to the bottom end of the radiating conductor plate.

In such an antenna device, the radiating conductor plate composed of a metal ribbon folded to meander can be folded a large number of times within a limited height without excessively decreasing the meander pitch. As a result, the radiating conductor plate advantageously allows for easy reduction of the size and the height, compared to a radiating conductor formed in a meandering shape by patterning. Further, the radiating conductor plate can advantageously have sufficient width to provide a wide frequency band. Furthermore, since the radiating conductor plate is easily manufactured from a metal conductor plate, such as a copper plate, by a pressing process, the antenna device is advantageously cost-effective.

The antenna device may include a capacitive conductor plate disposed substantially parallel to the ground conductor and connected to the top end of the radiating conductor plate and a connection conductor plate for electrically shorting the capacitive conductor plate to the ground conductor. The capacitive conductor plate functions as a shortening or loading capacitor, thereby decreasing the resonance frequency of the radiating conductor plate. Consequently, the electrical length of the radiating conductor plate required for resonating at a predetermined frequency becomes short, thereby further decreasing the height of the antenna device. In addition, since the capacitive conductor plate is shorted to the ground conductor via a connection conductor plate, impedance mismatching is avoided. Preferably, the top end of the radiating conductor plate is connected to substantially the center of the capacitive conductor plate so as to obtain a high antenna gain in the horizontal direction.

The radiating conductor plate may be composed of a folded metal ribbon that is a cut and bent portion of a flat metal sheet and the capacitive conductor plate may be composed of the remaining portion of the metal sheet. Thus, the radiating conductor plate and the capacitive conductor plate may be formed from a single metal sheet by a pressing process. A soldering operation that connects and fixes the both conductor plates together is not required, and so the antenna device can be manufactured at a low cost.

To achieve the second object described above, in addition to one of the above-described structures, an antenna device according to the present invention includes a second radiating conductor plate extending upwardly in a vertical direction and being connected to the bottom end of the above-described radiating conductor plate, wherein high-frequency power that has a higher frequency than that of the above-described high-frequency power is fed to the bottom end of the second radiating conductor plate.

In the antenna device, the second radiating conductor plate can operate as a monopole antenna whose electrical length is much shorter than that of the above-described meandering radiating conductor plate. Therefore, the meandering radiating conductor plate functions as a radiating element resonating at the first resonance frequency while the second radiating conductor plate functions as a radiating element resonating at a second frequency that is higher than the first resonance frequency. Accordingly, a high-performance dual-band antenna allowing for easy reduction of the size and the height can be obtained.

### BRIEF DESCRIPTION OF THE DRAWINGS

FIG. 1 is a perspective view of an antenna device according to a first embodiment of the present invention;

FIG. 2 is a side elevation view of an antenna device according to a second embodiment of the present invention;

FIG. 3 is a perspective view of an antenna device according to a third embodiment of the present invention;

FIG. 4 shows an example of a known antenna device having a meandering radiating conductor; and

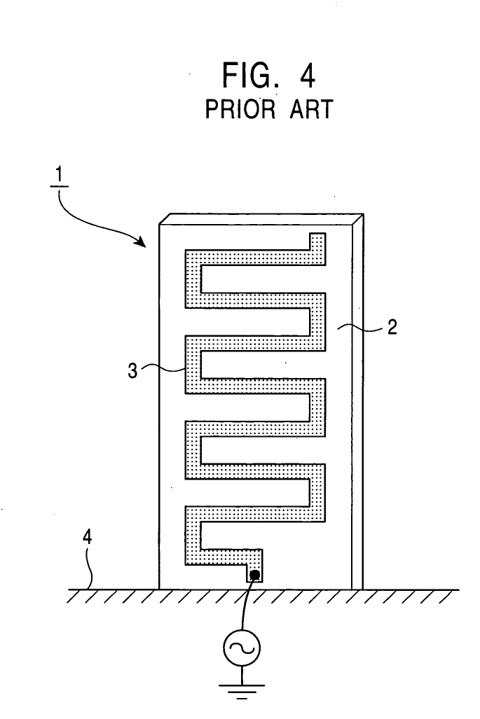

FIG. 5 shows an example of a known dual-band antenna device.

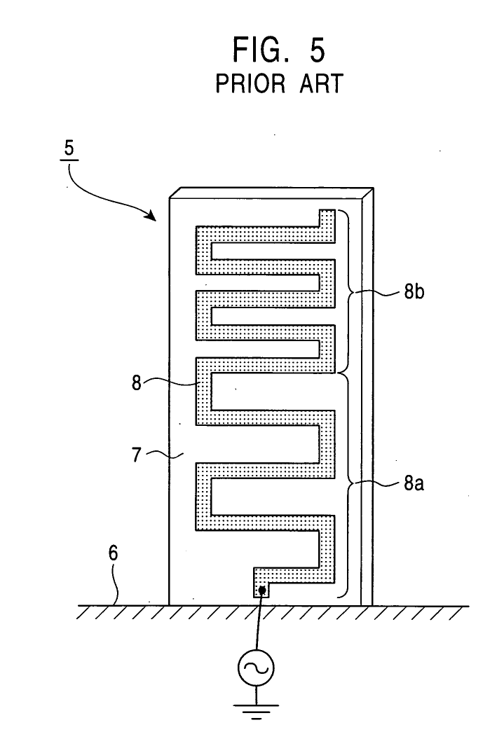

### DESCRIPTION OF THE PREFERRED EMBODIMENTS

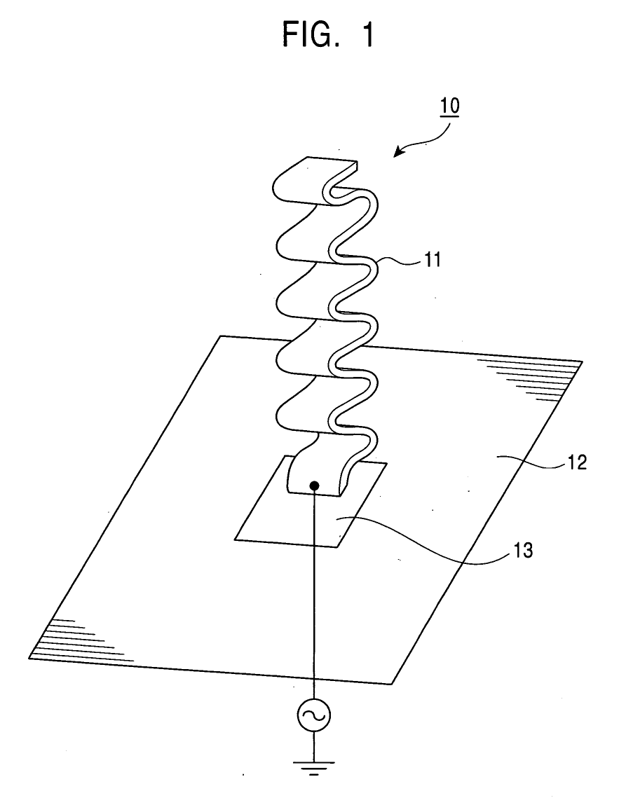

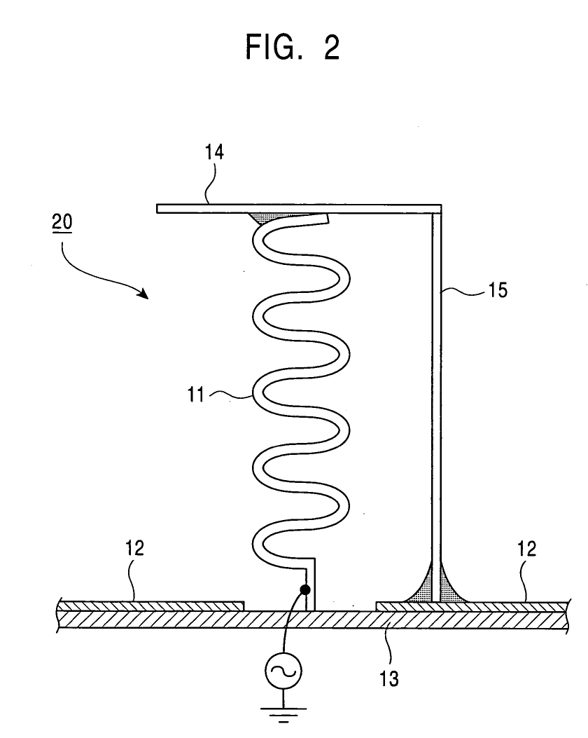

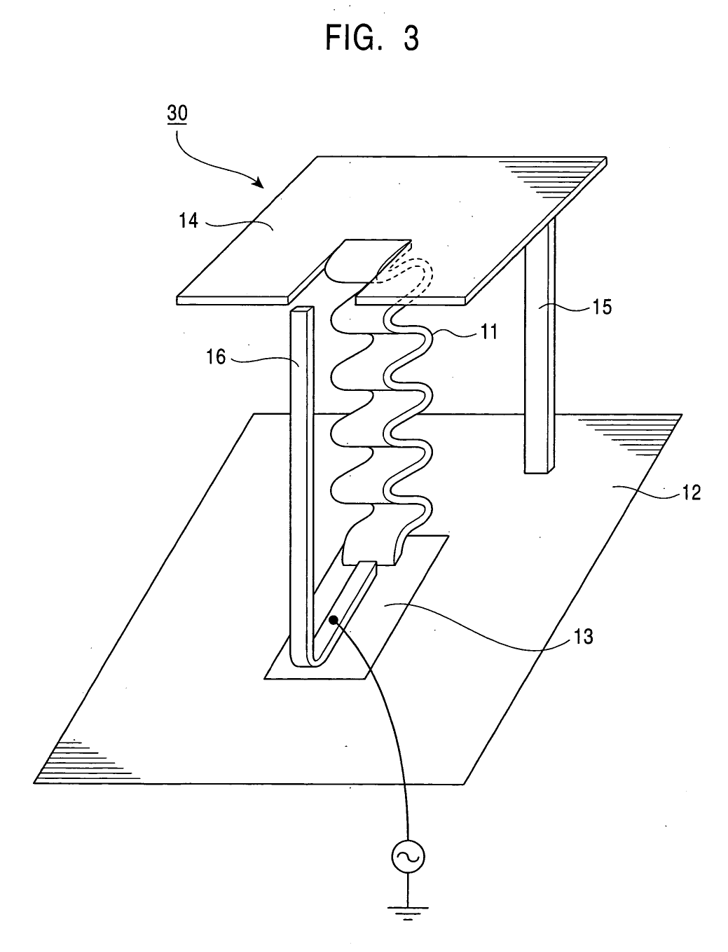

Embodiments of the present invention will now be described with reference to the drawings. FIG. 1 is a perspective view of an antenna device according to a first embodiment of the present invention. FIG. 2 is a side elevation view of an antenna device according to a second embodiment of the present invention. FIG. 3 is a perspective view of an antenna device according to a third embodiment of the present invention.

The first embodiment according to the present invention will now be described. An antenna device 10 shown in FIG. 1 includes a meandering radiating conductor plate 11 composed of a metal conductor plate, for example, a copper plate, having a predetermined width that is folded a plurality of times and a supporting substrate 13 having a ground conductor 12, wherein the radiating conductor plate 11 is vertically mounted on the supporting substrate 13 and high-frequency power is fed to the bottom end of the radiating conductor plate 11. The radiating conductor plate 11 is folded so as to meander with a meander pitch sufficient to suppress high-order modes by a bending process. In addition, the bottom end of the radiating conductor plate 11 is mounted through an opening in the ground conductor 12 without contacting the ground conductor 12 and is connected to a feed line such as a coaxial cable (not shown). The ground conductor 12 is composed of a conductive film such as a copper film, which is formed over substantially the entire surface of the insulating supporting substrate 13.

In this antenna device 10, the electrical length of the radiating conductor plate 11 is set to about one fourth of the selected wavelength so that the antenna device 10 can transmit or receive radio waves in a resonance frequency band by feeding predetermined high-frequency power to the radiating conductor plate 11 to excite it. The radiating conductor plate 11 composed of a metal ribbon folded in a meandering fashion can be folded a large number of times within a limited height without excessively decreasing the meander pitch. As a result, the height of the thin radiating conductor plate 11 does not increase while ensuring the required electrical length and a sufficient meander pitch to suppress high-order modes. Therefore, the size and the height of the antenna device 10 can easily be reduced. In addition, in spite of the small thickness, the radiating conductor plate 11 has sufficient width to provide a wide resonance frequency band, and hence the antenna device 10 provides a wide frequency band and ease of use. Since the radiating conductor plate 11 is easily manufactured from a metal conductor plate such as a copper plate by pressing, the antenna device 10 is advantageously cost-effective.

The second embodiment according to the present invention will now be described with reference to FIG. 2. In FIG. 2, the same reference numerals denote the corresponding elements in FIG. 1. Redundant descriptions will appropriately be omitted.

The main difference between an antenna device 20 shown in FIG. 2 and the antenna device 10 according to the first embodiment is as follows: in the structure of the antenna device 20, a capacitive conductor plate 14 disposed parallel to a ground conductor 12 is electrically and mechanically connected to the top end of a radiating conductor plate 11 and the capacitive conductor plate 14 is electrically shorted to the ground conductor 12 via a connection conductor plate 15. The capacitive conductor plate 14 is composed of a metal conductor plate like a copper plate, which is the same material as the radiating conductor plate 11. In this embodiment, the top end of the radiating conductor plate 11 is soldered to substantially the center of the capacitive conductor plate 14. The connection conductor plate 15 is mounted at an appropriate position where impedance mismatching can be avoided. In this embodiment, a metal ribbon downwardly extending from the capacitive conductor plate 14 serves as the connection conductor plate 15.

In this antenna device 20, the capacitive conductor plate 14 functions as a shortening capacitor, thereby decreasing the resonance frequency of the radiating conductor plate 11. Consequently, the electrical length of the radiating conductor plate 11 required for resonating at a predetermined frequency becomes short, thereby decreasing the height of the antenna device. Further, since the top end of the radiating conductor plate 11 is connected to substantially the center of the capacitive conductor plate 14, the antenna device 20 has a high antenna gain in the horizontal direction, thereby providing high-sensitivity transmission and reception in the horizontal direction.

The third embodiment according to the present invention will now be described with reference to FIG. 3. In FIG. 3, the same reference numerals denote the corresponding elements in FIGS. 1 and 2. Redundant descriptions will appropriately be omitted.

In an antenna device 30 shown in FIG. 3, a straight radiating conductor plate 16 is formed from a rising section of a ribbon which extends from the bottom end of the meandering radiating conductor plate 11. The straight radiating conductor plate 16 resonates at a second frequency f₂ that is higher than a first resonance frequency f₁ of the radiating conductor plate 11. That is, the straight radiating conductor plate 16 operates as a monopole antenna whose electrical length is much shorter than that of the meandering radiating conductor plate 11. The one radiating conductor plate 11 functions as a radiating element resonating at the first resonance frequency f₁ while the other radiating conductor plate 16 functions as a radiating element resonating at a second frequency f₂ that is higher than the first resonance frequency f₁. Accordingly, the antenna device 30 is an excellent dual-band antenna allowing for easy reduction of the size and the height and having a wide frequency band.

Unlike the above-described antenna device 20 according to the second embodiment, in the antenna device 30, the meandering radiating conductor plate 11 is composed of a folded metal ribbon that is a cut and bent portion of a flat metal sheet and the capacitive conductor plate 14 is composed of the remaining portion of the metal sheet. Accordingly, the capacitive conductor plate 14, the radiating conductor plate 11, and the straight radiating conductor plate 16 can be formed from a single metal sheet by a pressing process. A soldering operation that connects and fixes the conductor plates 14, 11, and 16 together is not required so that the antenna device 30, even though it is a dual-band antenna, can be manufactured at a relatively low cost.

What is claimed is:

1. An antenna device comprising:
a meandering radiating conductor plate comprising a metal ribbon folded a plurality of times; and
a supporting substrate having a ground conductor thereon;
wherein the radiating conductor plate is vertically mounted on the supporting substrate and first high-frequency power is fed to the bottom end of the radiating conductor plate.

2. An antenna device according to claim 1, further comprising:
a capacitive conductor plate disposed substantially parallel to the ground conductor and connected to the top end of the radiating conductor plate; and
a connection conductor plate for electrically shorting the capacitive conductor plate to the ground conductor.

3. An antenna device according to claim 2, wherein the top end of the radiating conductor plate is connected to substantially the center of the capacitive conductor plate.

4. An antenna device according to claim 2, wherein the radiating conductor plate comprises a folded metal ribbon that is a cut and bent portion of a flat metal sheet and the capacitive conductor plate comprises the remaining portion of the flat metal sheet.

5. An antenna device according to claim 1, further comprising a second radiating conductor plate extending upwardly in a vertical direction and connected to the bottom end of the radiating conductor plate;
wherein second high-frequency power that has a higher frequency than that of the first high-frequency power is fed to the bottom end of the second radiating conductor plate.
